(19) United States
(12) Patent Application Publication
(10) Pub. No.: US 2026/0195458 A1
(43) Pub. Date: Jul. 9, 2026

(54) VULNERABILITY DETECTION AND MANAGEMENT

(71) Applicant: Microsoft Technology Licensing, LLC, Redmond, WA (US)

(72) Inventors: George KIM, Fairfax, VA (US); Christopher B. MCCONNELL, Kenmore, WA (US); Benjamin David GOLDIN, Seattle, WA (US)

(73) Assignee: Microsoft Technology Licensing, LLC, Redmond, WA (US)

(21) Appl. No.: 19/013,710

(22) Filed: Jan. 8, 2025

(51) Int. Cl. G06F 21/57; G06F 21/55

(52) U.S. Cl. CPC G06F 21/577; G06F 21/552; G06F 21/554

(57) ABSTRACT

Systems and methods to provide vulnerability detection and management in a cloud computing system according to examples. More specifically, a vulnerability detection system receives access logs of a package repository and records information that links packages downloaded from the package repository to the computing assets that downloaded the packages. The vulnerability detection system evaluates an inventory of the package repository against a report of identified vulnerabilities (e.g., Common Vulnerabilities and Exposures (CVEs)). When a vulnerable package is identified in the inventory, the vulnerability detection system removes the vulnerable package from the package repository. The vulnerability detection system further determines affected assets and contact information of corresponding users and provides notifications to the users. In some examples, a mitigation or remediation is determined and provided to the users.

### BACKGROUND

A cloud computing platform is used to build, deploy, run, and manage software applications and services. For instance, the computing platform provides a wide range of services, including compute, analytics, storage, and networking, that users can select from to develop and scale new software applications or run existing applications.

A vulnerability is a security flaw in software that can be exploited by an attacker to compromise the confidentiality, integrity, or availability of a system. The term "zero-day" refers to the amount of time the vendor has to prepare a patch before the vulnerability is exploited. Thus, a zero-day vulnerability is considered more dangerous than known vulnerabilities because there are fewer countermeasures available. When a vendor learns about a vulnerability, they may notify a responsible organization so that a recommended workaround, such as uninstalling software, rolling back and updating software, configuration of other systems settings to limit or reduce exposure, etc., can be implemented before the vulnerability is made public. Once a zero-day vulnerability is made public, it is known as an n-day or one-day vulnerability. Early detection of a vulnerability can reduce the impact of the vulnerability. Additionally, mitigation of the vulnerability until a fix (e.g., remediation) is available can further reduce the impact of the vulnerability.

It is with respect to these and other considerations that examples have been made. In addition, although relatively specific problems have been discussed, it should be understood that the examples should not be limited to solving the specific problems identified in the background.

### SUMMARY

The technology described herein describes systems and methods to provide vulnerability detection and management/handling in a cloud computing system. A vulnerability detection system links software packages downloaded from a package repository to the computing assets that downloaded the packages and stores the links. The vulnerability detection system further evaluates an inventory of the package repository against a report of identified vulnerabilities (e.g., Common Vulnerabilities and Exposures (CVEs)). When a vulnerable package is identified in the inventory, the vulnerability detection system links the vulnerable package to the affected assets and to contact information of users associated with the affected assets. In some examples, notifications are provided to the users. In other examples, a fix for the identified vulnerability (e.g., mitigation steps) are received and included in the notifications. In yet other examples, mitigation steps are validated and validated mitigation steps are included in the notifications. In some implementations, the vulnerability detection system automatically runs a retraction to remove an identified vulnerable package from the package repository to prevent future downloads of the vulnerable package.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The present disclosure is illustrated by way of example by the accompanying figures, in which like references indicate similar elements. Elements in the figures are illustrated for simplicity and clarity and have not necessarily been drawn to scale.

FIG. 1 is a block diagram of an example operating environment in which a vulnerability detection system is implemented according to an example;

FIG. 2 depicts components of a vulnerability detection system according to an example;

FIG. 3 depicts a notification according to an example;

FIG. 4 depicts a flow diagram depicting a method of providing vulnerability detection and management according to an example; and

FIG. 5 is a block diagram illustrating example physical components of a computing device with which examples of the disclosure may be practiced.

### DETAILED DESCRIPTION

Implementations of the present disclosure use a vulnerability detection system to provide vulnerability detection and management in a cloud computing system according to examples. More specifically, the vulnerability detection system monitors access logs of a package repository that manages and distributes software packages hosted in the cloud computing system and records information about successful downloads of packages from the package repository. In examples, the recorded (download) information links the downloaded software packages to the specific assets that downloaded them. Additionally, the vulnerability detection system monitors vulnerability reports of software packages identified to have a vulnerability and detects vulnerable packages that are stored in the package repository. In examples, the vulnerability reports are continually updated and are continually monitored by the vulnerability detection system. The vulnerability detection system automatically further flags vulnerable packages that are stored in the package repository and maps the flagged packages to the specific assets that downloaded them based on the recorded download information. When affected assets are identified, the vulnerability detection system determines and notifies users (e.g., owners) of the affected assets. In some examples, the vulnerability detection system provides a report of relevant flagged packages with any available mitigation or remediation recommendations. According to an aspect, the vulnerability detection system further removes or otherwise prevents additional downloads of flagged packages from the package repository.

In examples, the vulnerable packages are identified on the service provider-side of the cloud computing system, rather than by the users of the assets that downloaded the vulnerable packages (e.g., customer/client-side). By identifying vulnerable packages on the service provider-side, the detection can be performed as vulnerabilities are reported. Further, the vulnerability detection system can map identified vulnerable packages to the associated affected assets in real time or near-real time, and then proactively notify the associated users of the identified vulnerabilities and the affected assets. In some examples, the recommended mitigation and/or remediation steps for an identified vulnerability (e.g., update to a new version of the vulnerable package or an alternative package) are included in a vulnerability report evaluated by the vulnerability detection system. In some implementations, mitigation and/or remediation steps for an identified vulnerability are first verified by the vulnerability detection system prior to providing the recommendations to the affected users.

Implementations of the present disclosure provide benefits, such as improved security, where affected assets of vulnerable packages are detected regardless of variations over a fleet of assets operated by a user. For instance, determining affected assets is not reliant on nuances or possible failures of a client system to execute properly. Thus, vulnerability detection and management provided by aspects of the present disclosure provide consistent and reliable identification of security threats. In some examples, affected assets of vulnerable packages are identified earlier than alternative approaches, thereby allowing the associated users to be notified and vulnerabilities to be mitigated and/or remediated earlier. Aspects of the vulnerability detection system enhance overall cloud computing system resilience and reduce the risk of undetected vulnerabilities, thereby preventing or minimizing damage to assets, data, infrastructure, etc., and enhancing the reliability of services that rely on software packages.

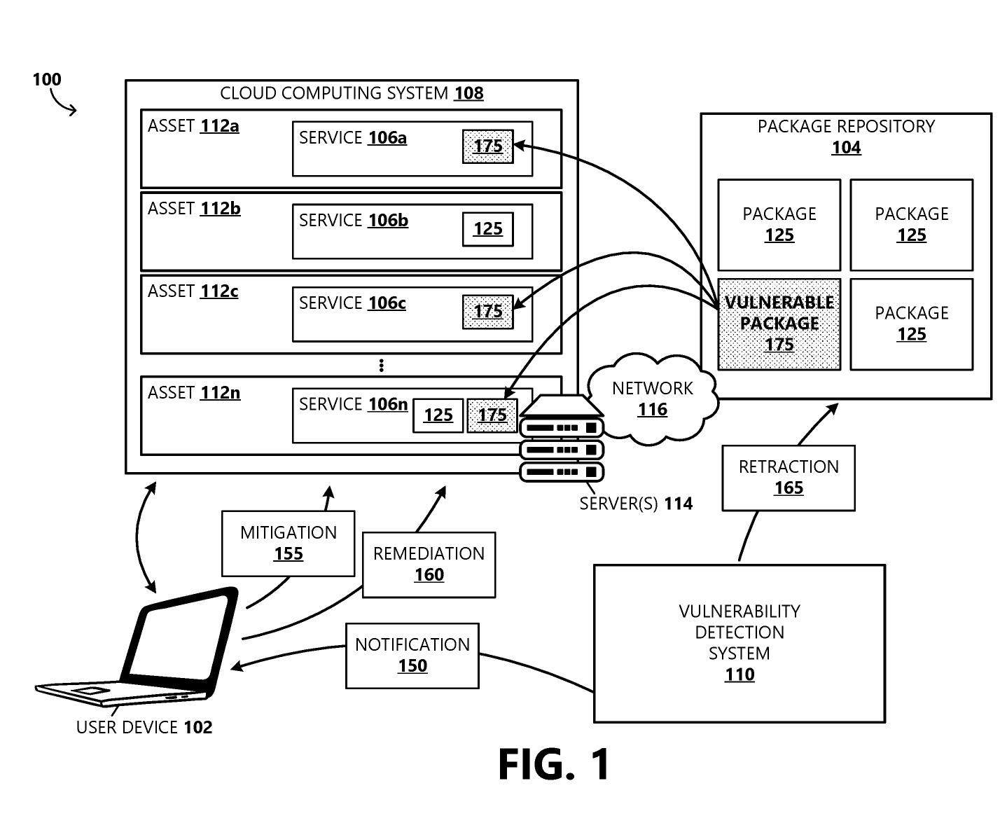

FIG. 1 is a block diagram illustrating an overview of an example operating environment 100 in which vulnerability detection and management is implemented according to an example. The operating environment 100 includes a cloud computing system 108 including one or more hardware and/or software components provided by a service provider. In aspects, the cloud computing system 108 includes and/or provides access to services 106a-106n (collectively, services 106) over one or a combination of networks 116. For instance, access to services 106 is provided to user devices 102 (e.g., personal computers (PCs), mobile devices (smartphones, tablets, laptops, personal digital assistants (PDAs)), wearable devices (smart watches, smart eyewear, fitness trackers, smart clothing, body-mounted devices, head-mounted displays), media devices, gaming consoles or devices, Internet of Things (IoT) devices, etc. In examples, components of the cloud computing system 108 are subject to various distributed computing models/services, such as Infrastructure as a Service (IaaS), Platform as a Service (PaaS), Software as a Service (SaaS), and Functions as a Service (FaaS). Although FIG. 1 is depicted as including a particular combination of computing environments and devices, the scale and structure of systems such as operating environment 100 and/or cloud computing system 108 may vary and may include additional or fewer components than those described in FIG. 1. As one example, the operating environment 100 may include multiple cloud computing systems 108, servers 114, and/or assets 112a-112n (collectively, assets 112). As another example, one or more user device(s) 102 may include or locally access one or more services 106. In some examples, a service 106 includes a plurality of service instances executed on servers 114 across one or more cloud computing systems 108. Further, the servers 114 may be implemented in data centers located in different geographic regions. Each geographic region includes its own set of servers 114 and infrastructure to handle the operations of the service instance.

In examples, a service 106 is built using one or more software packages (packages 125). A package 125 is a bundle of software that includes libraries, frameworks, and/or tools to provide a specific functionality or feature of a service 106. In examples, packages 125 may include programming languages (e.g., C, C++, Python), libraries, and/or software updates of operating systems (e.g., Windows, Android, or Linux). For instance, a security and identity management service 106 may be implemented using packages 125 that provide authentication protocols, encryption algorithms, user management application programming interfaces (APIs), etc. According to an aspect, when deploying a service 106 in a cloud computing system 108, one or more packages 125 are installed and configured on assets 112a-112n (collectively, assets 112). The term "asset" 112 is used herein to represent a resource that is provisioned and configured to perform specific tasks in the deployment and operation of a cloud-based service 106, such as virtual machines (VMs), containers, serverless functions, or hardware devices. In examples, a service provider provides assets 112 and manages packages 125 that are downloaded onto the assets 112 for utilization by a user, where the user is a customer of the service provider. For instance, the service provider may handle infrastructure and software management for the user.

A package repository 104 is a centralized location where packages 125 are stored, managed, and distributed. For instance, a snapshot of an inventory of the package repository 104 includes the packages 125 stored in the package repository 104 at the time of the snapshot. Packages 125 are stored in and downloaded from the package repository 104 for installation on an asset 112. In some examples, the package repository 104 provides newer versions of and/or patches (e.g., updates) for the packages 125 to ensure users can keep their services 106 up to date (e.g., in parity). For instance, services 106 rely on packages 125 that are updated to updated versions to ensure security, stability, and/or new features are available for the services 106. In some implementations, the package repository 104 is a public repository. In other implementations, the package repository 104 is a private repository.

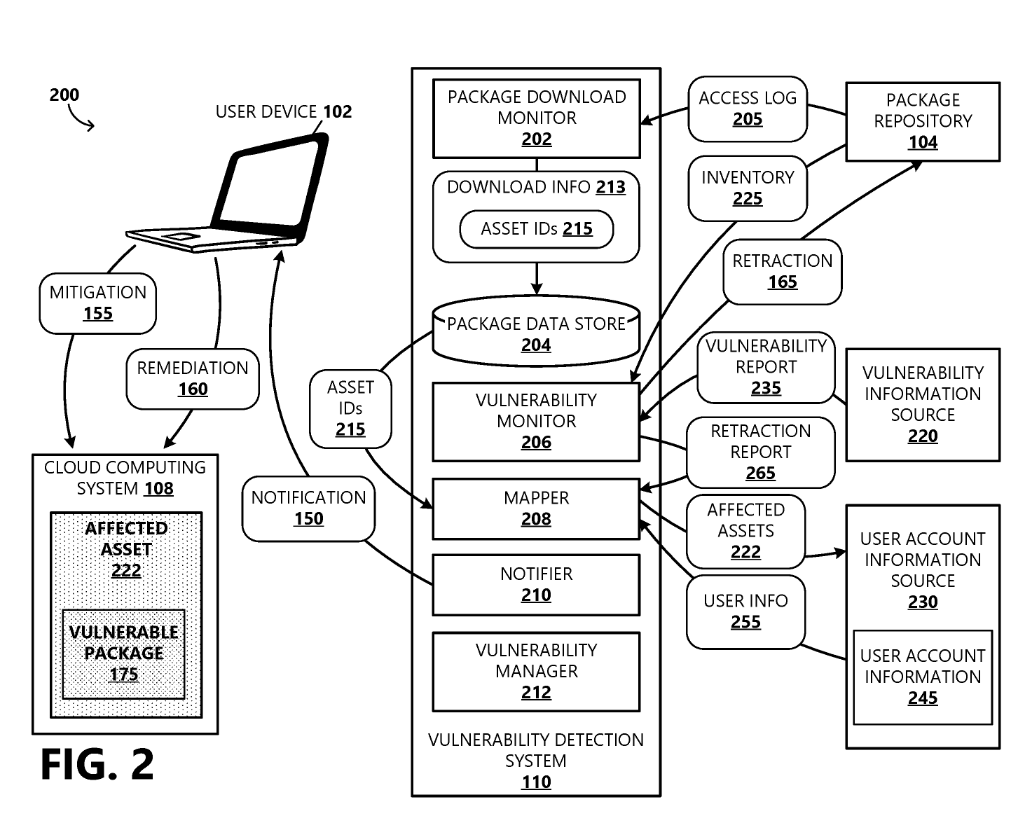

The operating environment 100 further includes a vulnerability detection system 110 that detects and manages security vulnerabilities in a cloud computing system 108. Generally, the vulnerability detection system 110 compares a list of packages 125 that are stored in the package repository 104 (e.g., an inventory of the package repository 104) against reported vulnerabilities (i.e., security flaws) and identifies vulnerable packages 175 based on the comparison. A package 125 that is determined to be associated with a reported vulnerability is referred to herein as a “vulnerable package” 175. According to examples, indications of reported vulnerabilities are included in a continuously updated report (e.g., a vulnerability report 235 shown in FIG. 2) evaluated by the vulnerability detection system 110.

In some implementations, the vulnerability detection system 110 automatically runs a retraction 165 on the package repository 104 based on the reported vulnerabilities to proactively prevent additional downloads of an identified vulnerable package 175. For instance, the vulnerability detection system 110 may automatically remove the vulnerable package 175 from the package repository 104 or otherwise prevent the vulnerable package 175 from being downloaded by another asset 112.

In some implementations, prior to identifying a package 125 stored in the package repository 104 as a vulnerable package 175, the vulnerability detection system 110 monitors downloads of packages 125 from the package repository 104 by one or more assets 112 (e.g., based on access logs associated with the package repository 104). Accordingly, when the package 125 is subsequently identified as vulnerable, the vulnerability detection system 110 maps the vulnerable package 175 to the asset(s) 112, which are then identified and flagged as “affected assets.” In examples, an affected asset 112 is an asset 112 that has downloaded a vulnerable package 175. In examples, the vulnerability detection system 110 further determines the users associated with identified affected assets 112 and provides notifications 150 to the users about the vulnerable packages 175, affected assets 112, and instructions on how to handle the identified vulnerabilities.

In some examples, the vulnerability detection system 110 receives or determines a mitigation 155 and includes the mitigation 155 in the instructions. The mitigation 155 may be represented as one or more recommended mitigation steps that can be performed (e.g., client-side) to manage an identified vulnerability. The mitigation 155 may not fix the vulnerability, but is used to maintain operational stability, minimize damage until the fix is determined, and/or provide another risk management functionality. Some example mitigation steps include disabling an affected asset 112, isolating an affected asset 112 (e.g., placing the affected asset 112 into a quarantine environment or a limited execution environment), monitoring the affected asset 112, etc. In some examples, the mitigation 155 or one or more mitigation steps of the mitigation 155 are included in the vulnerability report 235 (which is received from a vulnerability information source 220 shown in FIG. 2). In some implementations, the vulnerability detection system 110 verifies the mitigation 155 is applicable to the user of the affected asset 112 prior to providing the mitigation 155 in the notification 150.

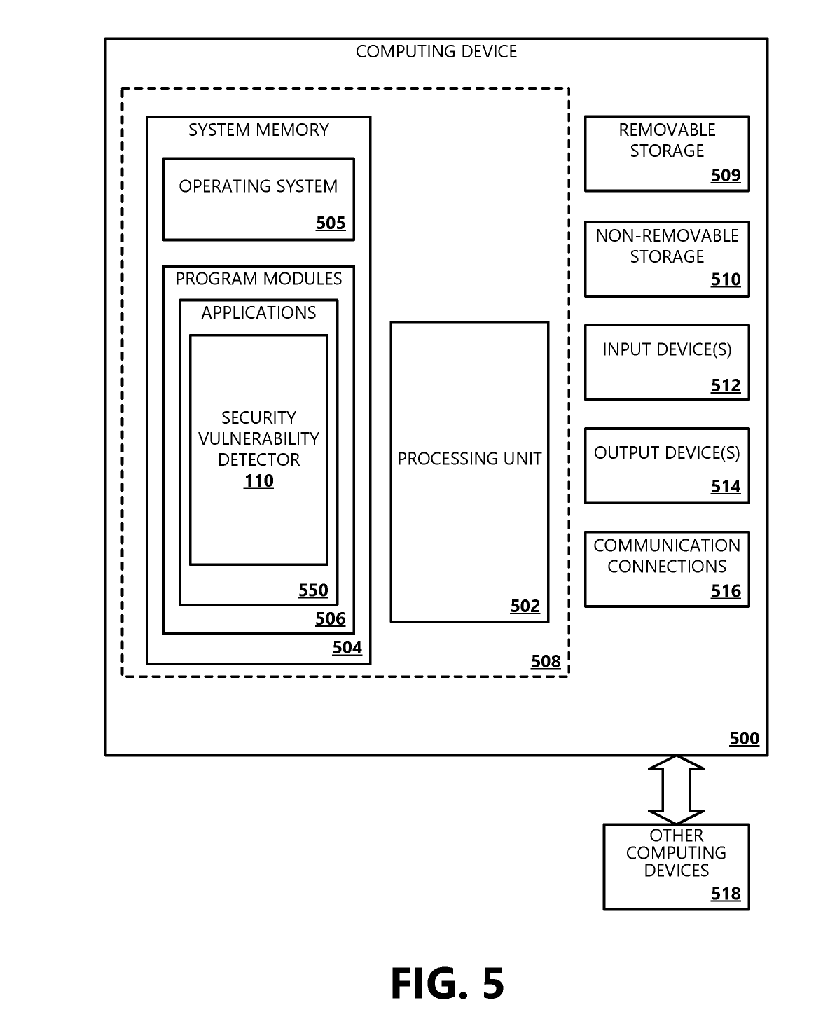

In other examples, the vulnerability detection system 110 receives or determines a remediation 160 and includes the remediation 160 in the instructions. For instance, the remediation 160 includes one or more recommended remediation steps that can be applied or performed (e.g., client-side) to fix and/or eliminate an identified vulnerability. Example recommended remediation steps that may be included in the instructions include updating to a new version or rolling back to a previous version of the identified vulnerable package 175, downloading an alternative package 125, applying a patch to the vulnerable package 175, etc. In some examples, a remediation 160 includes a link to the recommended fix. In some examples, the remediation 160 or one or more remediation steps (e.g., and links) of the remediation 160 are included in the received vulnerability report 235. In some implementations, the vulnerability detection system 110 verifies the remediation 160 is applicable to the user of the affected asset 112 prior to providing the remediation 160 in the notification 150. These and other examples are described below with reference to FIG. 2 – FIG. 5.

With reference now to FIG. 2, a diagram is depicted showing a data flow 200 to and/or from various components of the vulnerability detection system 110 according to an example implementation. In the depicted example implementation, the vulnerability detection system 110 includes a package download monitor 202, a package data store 204, a vulnerability monitor 206, a mapper 208, a notifier 210, and a vulnerability manager 212. In other implementations, the vulnerability detection system 110 may include additional, fewer, or different combinations of components than those depicted and described in FIG. 2. In some examples, the vulnerability detection system 110 includes one or more of the depicted components. In other examples, the vulnerability detection system 110 does not include, but is in communication with, one or more of the components.

In examples, the package download monitor 202 receives an access log 205 corresponding to the package repository 104. The access log 205 includes a list of packages 125 that have been downloaded from the package repository 104 by assets 112 in one or more cloud computing systems 108. In examples, the access log 205 includes information, such as an identifier (e.g., a Uniform Resource Locator (URL) or a Uniform Resource Identifier (URI)) of each package 125 requested by an asset 112 from the package repository 104, an identifier of the requestor of the package 125 (e.g., an asset identifier (ID) of the asset 112 from which the request for the package 125 is received, such as an Internet Protocol (IP) address, a port number, and/or a hostname), a status code (e.g., HyperText Markup Language (HTML) or JavaScript success/failure status of the request/download), timestamp, etc. The package download monitor 202 receives access logs 205 at regular (or irregular) time intervals in response to requests for the access logs 205, or another trigger. In examples, each received access log 205 includes a list of packages 125 requested for download from the package repository 104 since a previous time interval. For instance, the access logs 205 provide a snapshot of packages 125 that are on assets 112 of users’ cloud computing systems 108.

In examples, the package download monitor 202 identifies the requested packages 125 have been successfully downloaded (e.g., based on the status codes) and records information about those packages 125 and the downloads. The recorded information is stored as download information 213 in the package data store 204. In some examples, the download information 213 includes package metadata (e.g., the package name, version, description, author, last modification date/time) and a list of asset IDs 215 of the asset 112 that downloaded the specific package 125. In examples, download information 213 stored by the package data store 204 is updated based on most-recently received access logs 205. For instance, if an asset 112 downloads a second version of a package 125 (e.g., in an update from a first version), the download information 213 is updated to record a link between the asset ID 215 and the second version of the package 125.

In examples, the vulnerability monitor 206 obtains, queries, or otherwise accesses a vulnerability report 235 generated by a vulnerability information source 220. In some implementations, the vulnerability information source 220 is a publicly accessible database (e.g., National Vulnerability Database (NVD)) that provides information about officially recorded known vulnerabilities (e.g., Common Vulnerabilities and Exposures (CVEs) identified by unique CVE identifiers (IDs)). In examples, the vulnerability report 235 includes information about each vulnerability, such as a description, severity rating, impact, and mitigation 155 or remediation 160 recommendation. In some examples, the vulnerability monitor 206 further receives or otherwise accesses a report (referred to herein as an inventory 225) of the packages 125 stored in the package repository 104 and that are available to be downloaded by assets 112 in the cloud computing system 108. The inventory 225 may be provided by the package repository 104 or another information source.

The vulnerability monitor 206 compares the packages 125 in the inventory 225 to the vulnerable packages 175 in the vulnerability report 235 to identify vulnerable packages 175 included in the inventory 225. In further examples, the vulnerability monitor 206 matches the versions of the vulnerable packages 175 to the versions of the packages 125 in the inventory 225. The vulnerability monitor 206 updates the package data store 204 by marking or flagging the vulnerable packages 175 identified in the inventory 225.

According to an aspect, the vulnerability monitor 206 generates a retraction report 265 including the flagged vulnerable packages 175 identified in the vulnerability report 235. In some examples, the retraction report 265 is provided to the package repository 104, which triggers a retraction 165 of the vulnerable packages 175 in the retraction report 265 from the package repository 104. For instance, automated repository retractions 165 proactively prevent future downloads of identified vulnerable packages 175 from the package repository 104. In other examples, the retraction report 265 is provided to the mapper 208, where the mapper 208 is configured to map the vulnerable packages 175 included in the retraction report 265 to any assets 112 that may be affected by identified vulnerabilities. In some implementations, the vulnerability monitor 206 is a separate component from the vulnerability detection system 110 and communicates with the vulnerability detection system 110 over one or a combination of networks 116 to provide the retraction report 265 to the mapper 208.

The mapper 208 determines whether any assets 112 may be affected by the identified vulnerabilities by mapping the flagged vulnerable packages 175 to the asset IDs 215 of the assets 112 that downloaded them (represented as affected asset(s) 222 in FIG. 2). For instance, the mapper 208 is in communication with the package data store 204 and obtains the stored asset IDs 215 to determine the affected assets 222. In examples, the mapper 208 further maps the affected assets 222 to the users associated with the affected assets 222. For instance, the mapper 208 accesses user account information 245 from a user account information source 230, where the account information 245 includes user information 255, such as contact information for a user, and information about the assets 112 (e.g., including asset IDs 215) utilized by the user. The mapper 208 obtains user information 255 for contacting (e.g., providing notifications 150 to) the users affected by identified vulnerabilities.

The notifier 210 generates notifications 150 that include information about identified vulnerable packages 175 and affected assets 222. In examples, the notifier 210 further provides the notifications 150 to user devices 102 of the associated users based on the obtained user information 255. In some examples, the notifier 210 includes a recommendation of a mitigation 155 and/or remediation 160 in the notification 150. An example recommended mitigation 155 includes using a network security group (NSG) to limit access to the vulnerable package 175. For instance, the vulnerability manager 212 may define an NSG that the user can select to implement. An example recommended remediation 160 that may be included in the notification 150 includes removing the vulnerable package 175 or replacing the vulnerable package 175 with another version or another package 125. For instance, the vulnerability manager 212 may provide a recommendation to the user to remove the vulnerable package 175 from one or more affected assets 222. In some implementations, the vulnerability manager 212 monitors or otherwise receives and tracks indications of whether a recommended mitigation 155 or remediation 160 has been performed to limit impact of an identified vulnerability. In some examples, the notifier 210 escalates notifications 150 provided to users associated with affected assets 222. For instance, after a time period after a first notification 150 is sent and either an indication has not been received that a recommended mitigation 155 or remediation 160 has been performed or an indication is received that the recommended mitigation 155 or remediation 160 has not been performed, a second notification 150 may be sent and/or a plurality of subsequent notifications 150 may be sent until a determination is made that the vulnerability has been handled. The subsequent notifications 150 may escalate in type and/or frequency of communication. In some examples, the vulnerability detection system 110 receives a communication (e.g., email or other message) of completion of a mitigation 155 or remediation 160. The communication may be sent by a user, automatically by a user device 102, or automatically by an affected asset 112 upon handling of the vulnerable package 175 (e.g., performing the mitigation 155 or remediation 160).

According to an aspect, vulnerable packages 175 are detected early and affected assets 222 are determined automatically, which are then reported to the users associated with the affected assets 222. Accordingly, mitigation and/or remediation steps can be performed early to reduce the impact of the vulnerabilities. This is an improvement over current techniques, where users may be challenged with scanning vulnerability information for detecting vulnerable packages 175 that may have been downloaded to their assets 112. Or, currently, users receive a notification of a vulnerability, but then are tasked with determining which of their assets 112 are affected. This can be particularly challenging and time-consuming for users who operate a large number of assets 112 (e.g., 500 VMs), where a delay of detection, mitigation, and/or remediation of a vulnerability can result in increased security risk. According to another aspect, the service provider may serve dual roles as both a host (e.g., of the cloud computing system 108 and package repository 104) and a gatekeeper (e.g., for managing access to the cloud computing system 108 and package repository 104). Thus, CVE information and package access data are available to the vulnerability detection system 110 for generating a real time or near-real time mapping of industry-level vulnerabilities to users’ affected assets 222. Thus, aspects of the vulnerability detection system 110 described herein provide increased security in cloud computing systems 108.

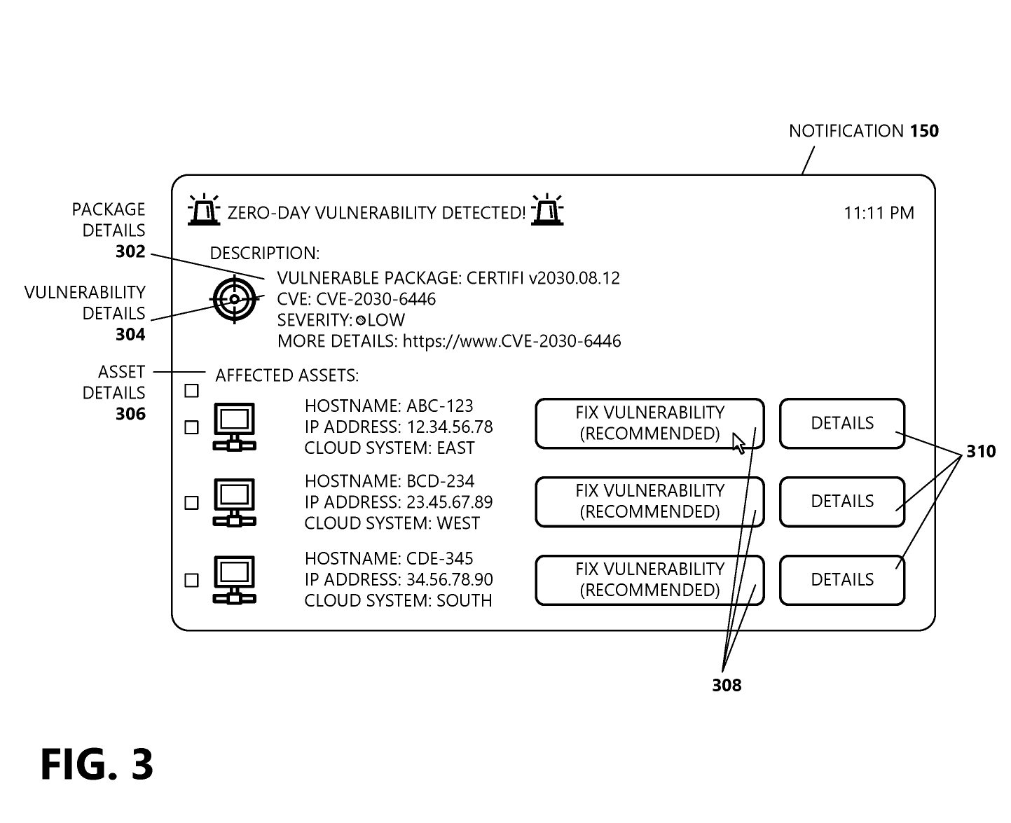

With reference now to FIG. 3, an example notification 150 is depicted. In examples, the notification 150 is in the form of an email, text message, pop-up message, etc. In some examples, prior permission is given by the user to allow the vulnerability detection system 110 to automatically provide a notification 150 to the user when a vulnerability associated with the user’s assets 112 is detected. In some implementations, the notification 150 includes information about a detected vulnerable package 175, such as package details 302 (e.g., package name, version, description), vulnerability details 304 (e.g., CVE ID, severity level, link to more information), and affected asset details 306 (e.g., IP address, hostname, cloud computing system 108), etc. In some examples, the notification 150 includes instructions, such as one or more mitigation steps (e.g., of a recommended mitigation 155) that can be performed to manage an identified vulnerability or one or more remediation steps (e.g., of a recommended remediation 160) that can be performed to fix and/or eliminate the identified vulnerability. According to an example, the remediation step(s) include a link to the recommended fix (e.g., a link to a new version of the vulnerable package 175, a previous version of the vulnerable package 175, an alternative package 125, or a patch to the vulnerable package 175). In some examples, additional and/or alternative selectable options 310 are included in the notification 150 that may be selected to provide additional information about the identified vulnerability, recommended mitigation 155, and/or remediation 160.

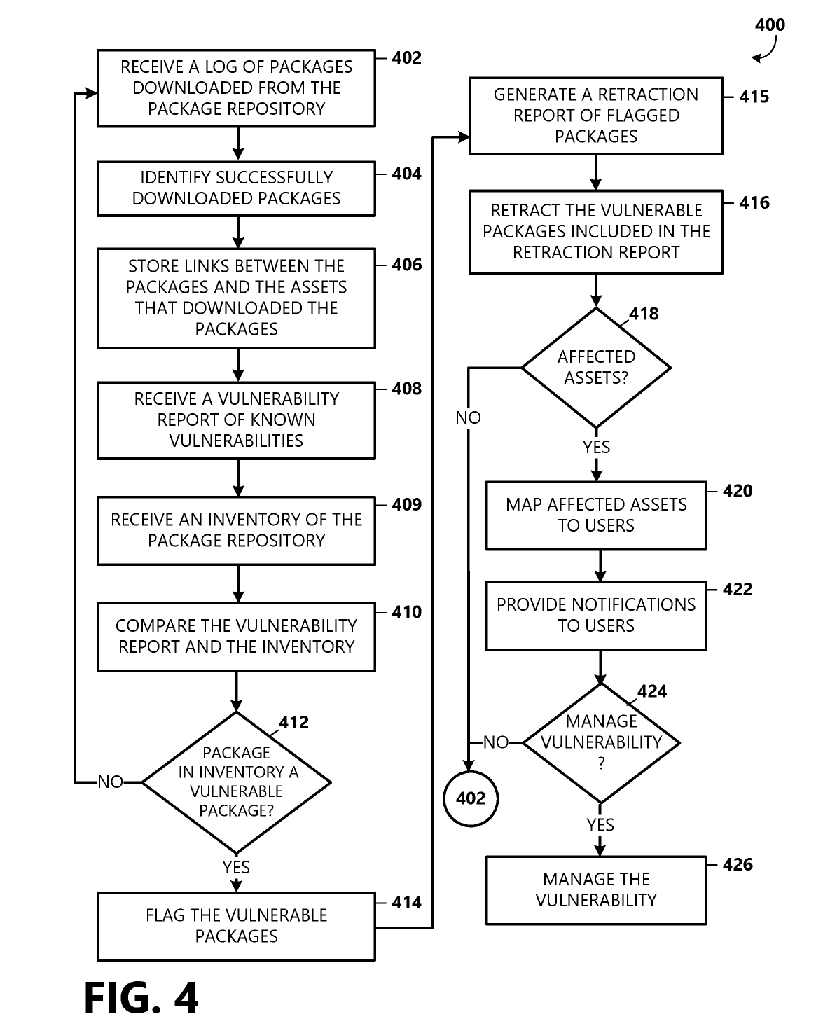

With reference now to FIG. 4, a flow diagram of an example method 400 for providing vulnerability detection and management is depicted. At operation 402, the vulnerability detection system 110 receives an access log 205 of a package repository 104. In examples, the access log 205 includes a list of packages 125 that have been requested for download from the package repository 104 within a time interval (e.g., since a last time interval) and information about the requests. For instance, the access log 205 includes an identifier of a requested package 125, an asset ID 215 of the requestor of the package 125, a status of the request (e.g., success or failure of the download), a timestamp, and/or other information.

At operation 404, the vulnerability detection system 110 uses the status information to identify successfully downloaded packages 125 and, at operation 406, records download information 213 including asset IDs 215 of the assets 112 that successfully downloaded the packages 125. For instance, the package download monitor 202 records a link between an asset 112 and a successfully downloaded package 125 by the asset 112. In examples, the download information 213 is stored in the package data store 204 and includes metadata about the corresponding packages 125, such as the version of the packages 125, URLs of the packages 125, etc.

At operation 408, the vulnerability detection system 110 (e.g., the vulnerability monitor 206 included in or communicatively connected to the vulnerability detection system 110) receives or otherwise accesses a vulnerability report 235 (e.g., a report of known vulnerabilities) provided by a vulnerability information source 220. In some examples, the vulnerability information source 220 is the NVD and the vulnerability report 235 is a report of officially recorded vulnerabilities (e.g., CVEs).

At operation 409, the vulnerability detection system 110 receives or otherwise accesses an inventory 225 of the packages 125 stored in the package repository 104. In some examples, the inventory 225 is provided by the package repository 104.

At operation 410, the vulnerability detection system 110 compares the inventory 225 to the vulnerability report 235 to identify any vulnerable packages 175 included in the vulnerability report 235 that are stored in the package repository 104.

At decision operation 412, the vulnerability monitor 206 makes a determination as to whether any packages identified as a vulnerability in the vulnerability report 235 match a package 125 included in the inventory 225. When a determination is made that there are not any vulnerable packages 175 included in the inventory 225, the method returns to operation 402, where a next access log 205 is received. Alternatively, when a match is determined, a vulnerable package 175 is identified and, at operation 414, the vulnerable package 175 is flagged as a vulnerability.

For instance, the download information 213 stored in the package data store 204 is updated to flag the corresponding package 125 as a vulnerable package 175. In some examples, updating the package data store 204 includes adding a flag or other indicator to the metadata of the vulnerable package 175, moving the vulnerable package 175 to a quarantine list, adding the vulnerable package 175 to a deletion queue, etc.

At operation 415, the vulnerability detection system 110 generates a retraction report 265 including the vulnerable package 175 flagged at operation 414. At operation 416, the vulnerability detection system 110 initiates or triggers a retraction 165 on the package repository 104 to remove the flagged vulnerable package 175 from the package repository 104. In some examples, sending the retraction report 165 to the package repository 104 triggers the retraction 165.

At decision operation 418, the vulnerability detection system 110 makes a determination as to whether an asset 112 may be affected by identified vulnerabilities (e.g., whether the vulnerable package 175 was downloaded by an asset 112). In some examples, the vulnerability detection system 110 accesses the download information 213 stored in the package data store 204 to determine which one or more assets 112 (if any) are linked to the flagged vulnerable package 175. For example, the vulnerability detection system 110 uses the recorded asset IDs 215 to identify one or more affected assets 222 that have downloaded the vulnerable package 175.

At operation 420, the vulnerability detection system 110 maps the one or more affected assets 222 to one or more associated users. For instance, the asset ID 215 of each affected asset 222 is mapped to a user account based on user account information 245 accessed from a user account information source 230. In some examples, user account information 245 further includes user information 255, such as contact information for the user(s). In some examples, a plurality of affected assets 222 are operated by a single user (e.g., a customer).

At operation 422, the vulnerability detection system 110 generates and provides a notification 150 to the one or more users of the affected assets 222. In some examples, the notification 150 is provided in the form of an email, text message, pop-up message, or other notification medium. In some implementations, prior permission is received from the user for allowing the vulnerability detection system 110 to provide the notification 150 when a vulnerability is detected. In some examples, the notification 150 includes information about the detected vulnerability, such as package details 302 of the vulnerable package 175, vulnerability details 304, asset details 306, recommended next steps (e.g., mitigation 155 and/or remediation 160 steps), selectable options 308 to trigger and/or perform a recommended mitigation 155 and/or remediation 160, etc. In some implementations, the recommended next steps are received in the vulnerability report 235. In some examples, the vulnerability report 235 includes a link to a recommended remediation 160 (e.g., a patch or update to the vulnerable package 175, a new version of the vulnerable package 175, or a different package 125). In further examples, prior to including a recommended mitigation 155 and/or remediation 160 in the notification 150, the vulnerability detection system 110 verifies the mitigation 155 and/or remediation 160 steps can be successfully applied by the user to the affected assets 222. For instance, a determination may be made based on whether the new version of the vulnerable package 175 or other recommended package 125 is available, a check that updating, rolling back, or changing, the vulnerable package 175 will not break any dependencies, an asset resource verification, a configuration compatibility verification, version compatibility, rollback plan, etc.

At decision operation 424, the vulnerability detection system 110 makes a determination about whether to further manage the vulnerability. In some implementations, a determination is made to escalate (e.g., type and/or frequency of) notifications 150 provided to user(s) associated with affected assets 222 and, at operation 426, an action is performed to further handle the vulnerability. As an example, after a time period after a first notification 150 is sent and a recommended mitigation 155 or remediation 160 has not been performed, a second notification 150 may be sent and/or a plurality of subsequent notifications 150 may be sent until the vulnerability is handled. In some examples, the vulnerability detection system 110 monitors or otherwise receives an indication of completion of a mitigation 155 or remediation 160 at decision operation 426. When a determination is made that further management/handling of the vulnerability is not needed, the method 400 returns to operation 402.

FIG. 5 and the associated description provide a discussion of a variety of operating environments in which examples of the invention may be practiced. However, the devices and systems illustrated and discussed with respect to FIG. 5 is for purposes of example and illustration and is not limiting of a vast number of computing device configurations that may be utilized for practicing aspects of the invention, described herein. FIG. 5 is a block diagram illustrating physical components (i.e., hardware) of a computing device 500 with which examples of the present disclosure may be practiced. In a basic configuration, the computing device 500 may include at least one processing unit and a system memory 504. in examples, the processing unit(s) (e.g., processors) are referred to as a processing system 502. Depending on the configuration and type of computing device, the system memory 504 may comprise volatile storage (e.g., random access memory), non-volatile storage (e.g., read-only memory), flash memory, or any combination of such memories. The system memory 504 may include an operating system 505 and one or more program modules 506 suitable for running software applications 550 (e.g., vulnerability detection system 110).

The operating system 505, for example, may be suitable for controlling the operation of the computing device 500. Furthermore, aspects of the invention may be practiced in conjunction with a graphics library, other operating systems, or any other application program and is not limited to any particular application or system. This basic configuration is illustrated in FIG. 5 by those components within a dashed line 508. The computing device 500 may have additional features or functionality. For example, the computing device 500 may also include additional data storage devices (removable and/or non-removable) such as, for example, magnetic disks, optical disks, or tape. Such additional storage is illustrated in FIG. 5 by a removable storage device 509 and a non-removable storage device 510.

As stated above, a number of program modules and data files may be stored in the system memory 504. While executing on the processing system 502, the program modules 506 may perform processes including one or more of the operations of the method 400 illustrated in FIG. 4. Other program modules that may be used in accordance with examples of the present invention and may include applications such as electronic mail and contacts applications, word processing applications, spreadsheet applications, database applications, slide presentation applications, drawing or computer-aided application programs, etc.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 5 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to generating suggested queries, may be operated via application-specific logic integrated with other components of the computing device 500 on the single integrated circuit (chip). Examples of the present disclosure may also be practiced using other technologies capable of performing logical operations such as, for example, AND, OR, and NOT, including mechanical, optical, fluidic, and quantum technologies.

The computing device 500 may also have one or more input device(s) 512 such as a keyboard, a mouse, a pen, a sound input device, a touch input device, etc. The output device(s) 514 such as a display, speakers, a printer, etc. may also be included. The aforementioned devices are examples and others may be used. The computing device 500 may include one or more communication connections 516 allowing communications with other computing devices 518. Examples of suitable communication connections 516 include RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 504, the removable storage device 509, and the non-removable storage device 510 are all computer storage media examples (i.e., memory storage.) Computer storage media may include RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information, and which can be accessed by the computing device 500. Any such computer storage media may be part of the computing device 500. Computer storage media does not include a carrier wave or other propagated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, communication media may include wired media such as a wired network or direct-wired connection, and wireless media such as acoustic, radio frequency (RF), infrared, and other wireless media.

According to an aspect, a method is provided, comprising: receiving an indication that a first package has been downloaded by a first asset from a package repository; recording a first asset identifier of the first asset as linked to the first package; comparing a first inventory of the package repository against a first report of identified vulnerabilities; determining the first package is a first vulnerable package when the first package is included in the first report; mapping the first vulnerable package to the first asset based on the first asset identifier; determining the first asset is a first affected asset; mapping the first affected asset to a first user account; and providing a first notification about the first vulnerable package and the first affected asset to a user of the first user account.

According to an aspect, a computer system is provided comprising: a processing system; and memory comprising computer program instructions for performing operations comprising: receiving an access log including details about requests made to a package repository in an interval; identifying a package downloaded from the package repository by an asset based on the details included in the access log; recording, in association with the package, an asset identifier corresponding to the asset; receiving a retraction report indicating an identified vulnerable package; mapping the vulnerable package to the asset based on the asset identifier; determining the asset is an affected asset; mapping the affected asset to a user account; and providing a mitigation or remediation for the vulnerable package downloaded by the affected asset to a user of the user account.

According to an aspect, a method is provided, comprising: receiving an access log including details about requests made to a package repository in an interval; identifying a package has been successfully downloaded from the package repository by an asset based on the details included in the access log; recording, in association with the package, an asset identifier corresponding to the asset; comparing an inventory of the package repository against a report of identified vulnerabilities; flagging the package as a vulnerable package when the package is included in the inventory and the report; retracting the vulnerable package from the package repository; mapping the vulnerable package to the asset based on the asset identifier corresponding to the asset; determining the asset is an affected asset; mapping the affected asset to a user account; and providing a notification about the vulnerable package and the affected asset to a user of the user account.

Aspects of the present invention, for example, are described above with reference to block diagrams and/or operational illustrations of methods, systems, and computer program products according to aspects of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved. Further, as used herein and in the claims, the phrase “at least one of element A, element B, or element C” is intended to convey any of: element A, element B, element C, elements A and B, elements A and C, elements B and C, and elements A, B, and C.

The description and illustration of one or more examples provided in this application are not intended to limit or restrict the scope of the invention as claimed in any way. The aspects, examples, and details provided in this application are considered sufficient to convey possession and enable others to make and use the best mode of claimed invention. The claimed invention should not be construed as being limited to any aspect, example, or detail provided in this application. Regardless of whether shown and described in combination or separately, the various features (both structural and methodological) are intended to be selectively included or omitted to produce an example with a particular set of features. Having been provided with the description and illustration of the present application, one skilled in the art may envision variations, modifications, and alternate examples falling within the spirit of the broader aspects of the general inventive concept embodied in this application that do not depart from the broader scope of the claimed invention.

We claim:

1. A method, comprising:
receiving an indication that a first package has been downloaded by a first asset from a package repository;
recording a first asset identifier of the first asset as linked to the first package;
comparing a first inventory of the package repository against a first report of identified vulnerabilities;
determining the first package is a first vulnerable package when the first package is included in the first report;
mapping the first vulnerable package to the first asset based on the first asset identifier;
determining the first asset is a first affected asset;
mapping the first affected asset to a first user account; and
providing a first notification about the first vulnerable package and the first affected asset to a user of the first user account.

2. The method of claim 1, further comprising:
adding the first vulnerable package to a retraction report; and
triggering a retraction of the first vulnerable package from the package repository by sending the retraction report.

3. The method of claim 1, wherein receiving the indication that the first package has been successfully downloaded by the first asset comprises receiving a first access log of the package repository including a record of:
a request for the first package by the first asset;
the first asset identifier of the first asset;
a package identifier of the first package; and
a status indication of a successful download of the first package by the first asset.

4. The method of claim 3, further comprising:
prior to receiving the first access log, receiving a second access log of the package repository including an indication that the first package has been successfully downloaded by a second asset;
prior to receiving the first access log, recording a second asset identifier of the second asset as linked to the first package;
in response to determining the first package is the first vulnerable package, mapping the first vulnerable package to the second asset based on the second asset identifier;
determining the second asset is a second affected asset;
mapping the second affected asset to a second user account; and
providing a second notification about the first vulnerable package and the second affected asset to a user of the second user account.

5. The method of claim 4, wherein:
the first user account and the second user account are a same account; and
providing the second notification comprises including information about the second affected asset in the first notification.

6. The method of claim 1, wherein the first asset comprises a plurality of assets.

7. The method of claim 1, further comprising:
receiving an indication of a recommended mitigation or remediation for the first vulnerable package; and
including, in the first notification, the recommended mitigation or remediation.

8. The method of claim 7, further comprising, prior to including the recommended mitigation or remediation in the first notification, verifying the recommended mitigation or remediation for the first affected asset.

9. The method of claim 7, further comprising:
monitoring the first affected asset;
determining to manage the first vulnerable package; and
providing a second notification to the user of the first user account.

10. The method of claim 1, further comprising:
receiving an indication that a second package has been downloaded by a second asset from the package repository;
recording, in association with the second package, an asset identifier corresponding to the second asset;
comparing a second inventory of the package repository against a second report of identified vulnerabilities, the second report published after the first report;
determining the second package is a second vulnerable package when the second package is included in the second report;
mapping the second vulnerable package to the second asset based on the asset identifier corresponding to the second package;
determining the second asset is a second affected asset;
mapping the second affected asset to a second user account; and
providing a second notification about the second vulnerable package and the second affected asset to a user of the second user account.

11. A system, comprising:
a processing system; and
memory storing instructions that, when executed, cause the system to perform operations comprising:
receiving an access log including details about requests made to a package repository in an interval;
identifying a package downloaded from the package repository by an asset based on the details included in the access log;
recording, in association with the package, an asset identifier corresponding to the asset;
receiving a retraction report indicating an identified vulnerable package;
mapping the vulnerable package to the asset based on the asset identifier;
determining the asset is an affected asset;
mapping the affected asset to a user account; and
providing a mitigation or remediation for the vulnerable package downloaded by the affected asset to a user of the user account.

12. The system of claim 11, wherein receiving the retraction report comprises:
receiving an inventory of the package repository;
receiving a report of identified vulnerabilities;
comparing the report with the inventory; and
in response to determining the package is included in the report and the inventory:
generating the retraction report; and
indicating, in the retraction report, the package is the vulnerable package.

13. The system of claim 12, the operations further comprising:
in response to indicating the package is the vulnerable package in the retraction report, triggering a retraction of the vulnerable package from the package repository.

14. The system of claim 12, wherein the vulnerabilities included in the report are Common Vulnerabilities and Exposures (CVEs).

15. The system of claim 12, the operations further comprising:
receiving an indication of the mitigation or remediation for the vulnerable package in the report of identified vulnerabilities; and
including, in a notification to the user, the recommended mitigation or remediation.

16. The system of claim 11, wherein the mitigation or remediation includes at least one of:
recommended steps;
a link to a new version of the vulnerable package;
a link to a patch to the vulnerable package; or
a link to a replacement package for the vulnerable package.

17. A method, comprising:
receiving an access log including details about requests made to a package repository in an interval;
identifying a package has been successfully downloaded from the package repository by an asset based on the details included in the access log;
recording, in association with the package, an asset identifier corresponding to the asset;
comparing an inventory of the package repository against a report of identified vulnerabilities;
flagging the package as a vulnerable package when the package is included in the inventory and the report;
retracting the vulnerable package from the package repository;
mapping the vulnerable package to the asset based on the asset identifier corresponding to the asset;
determining the asset is an affected asset;
mapping the affected asset to a user account; and
providing a notification about the vulnerable package and the affected asset to a user of the user account.

18. The method of claim 17, wherein retracting the vulnerable package comprises:
generating a retraction report including packages flagged as vulnerable packages; and
sending the retraction report to the package repository.

19. The method of claim 17, further comprising:
receiving an indication of a recommended mitigation or remediation for the vulnerable package; and
including, in the notification, the recommended mitigation or remediation.

20. The method of claim 19, further comprising:
prior to including the recommended mitigation or remediation in the notification, verifying the recommended mitigation or remediation for the affected asset; and
including the verified recommended mitigation or remediation in the notification.
